(19) United States
(12) Patent Application Publication
(10) Pub. No.: US 2003/0108820 A1
(43) Pub. Date: Jun. 12, 2003

(54) Use of glass capable of recrystallization as mineral binder of an electrode paste for a plasma panel

(76) Inventors: Guy Baret, Grenoble (FR); Armand Bettinelli, Voiron (FR)

Correspondence Address: Joseph S Tripoli, Thomson Multimedia Licensing Inc, CN 5312, Princeton, NJ, 08543-0028, US

(21) Appl. No.: 10/181,340

(22) PCT Filed: Jan. 2, 2001
(86) PCT No.: PCT/FR01/00004

(30) Foreign Application Priority Data
Jan. 17, 2000 (FR) 00/00510

(51) Int. Cl. H01J 9/02

(52) U.S. Cl. 430/315

(57) ABSTRACT

The present invention relates to a process for manufacturing a plasma panel tile, comprising the deposition of electrodes, using a paste comprising a metal powder and a mineral binder, and the baking of the deposited electrodes.

According to the invention, the composition of the mineral binder and the baking conditions are tailored so that, after the deposited electrodes have been baked, the binder is in the recrystallized state.

Owing to the recrystallized state of the binder, the yellowing problems which occur during subsequent heat treatments are eliminated.

The present invention relates to a paste for producing electrodes on a glass substrate and to a process for manufacturing a plasma panel tile. The invention relates more particularly to the production of electrodes on substrates made of glass, especially of the soda-lime type, such as those used for plasma panels.

In order to simplify the description and to better understand the problem posed, the present invention will be described with reference to the manufacture of plasma panels. However, it is obvious to those skilled in the art that the present invention is not limited to the process for manufacturing plasma panels but can be used in all types of process requiring materials of the same kind under similar conditions.

As known from the prior art, plasma panels, generally called PPs, are display screens of the flat type which operate on the principle of an electrical discharge in a gas accompanied by the emission of light. In general, PPs consist of two insulating tiles made of glass, conventionally of the soda-lime type, each supporting at least one array of conducting electrodes and defining a gas space between them. The tiles are joined together so that the electrode arrays are orthogonal. Each electrode intersection defines an elementary light cell filled with discharge gas.

The electrodes of a plasma panel must have a certain number of characteristics, especially when they are used on the front tile. Thus, they must be small in cross section, namely of the order of a few hundred μm², in order not to impede the viewing. They must be made from a material which is a good conductor, giving electrodes having a resistance of less than 100 ohms. In addition, the material used must be able to allow lower-cost mass production.

At the present time, two techniques are used for producing the electrodes of a plasma panel.

The first technique consists of thin-film metal deposition which may be carried out by sputtering or by vacuum evaporation. In this case, the material used is aluminium or copper. It may also consist of a copper or aluminium layer placed between two chromium layers. This metal coating is etched locally in order to define the electrodes. The cost of this technique is relatively high because of the vacuum deposition and of the treatment of the etching effluents.

The second technique consists in depositing a silver-based paste or ink. Such a paste contains a silver powder or a metal powder mixture containing at least 70% silver. It also contains a mineral binder. In addition, it contains organic compounds, especially resins, solvents and, optionally, additives. The paste is deposited either locally, by direct screen printing, or over the entire surface if a photosensitive paste is used. The layer deposited on the tile is then exposed using a mask. The exposed paste is developed in an alkaline aqueous medium and then the whole assembly is baked at a temperature generally of between 500° C. and 600° C. This technique is particularly inexpensive as it does not require a vacuum deposition plant.

In this technique, the mineral binder used with the silver powder is a glass frit suitable for sintering, in liquid medium, the silver particles of the paste during the baking and for making the electrodes adhere to the glass substrate. Documents SU 1 220 497, U.S. Pat. No. 5,851,732 and U.S. Pat. No. 5,972,564 describe mineral binder compositions that can be used for this purpose, and especially compositions which allow the adhesion to the substrate to be increased.

Document U.S. Pat. No. 5,851,732 teaches that the softening temperature of this mineral binder has a major influence on the temperature at which the baking should be carried out; that document discloses compositions whose softening temperature is substantially less than 500° C.

Finally, this mineral binder must be able to withstand the baking of the dielectric layer deposited on the glass substrate provided with electrodes, this baking generally being carried out at a temperature above the baking temperature of the electrode paste; the conditions under which the dielectric layer is baked are suitable for obtaining smooth and compact surfaces on the surface of the cells, where electrical discharges will take place; the maximum temperature reached during the baking of the dielectric layer generally exceeds 500° C.; this baking may be carried out simultaneously with that of the electrode paste, as described in document JP11-329236.

However, the baking of the dielectric layer, especially at a temperature above 500° C., may result in the following drawbacks:

formation of bubbles and/or migration of the silver into the dielectric layer, which result in a particularly irksome yellowish coloration;

fracture of electrode patterns and loss of adhesion to the substrate.

The object of the present invention is therefore to provide a paste for producing the electrodes and a process for manufacturing the plasma panel tiles allowing these drawbacks to be avoided in a very inexpensive manner.

Thus, the subject of the present invention is a process for manufacturing a plasma panel tile, comprising the following steps:

deposition of electrodes on a substrate, in a defined pattern, using a paste comprising a metal powder, a mineral binder and organic compounds;

baking of the said deposited electrodes under conditions suitable for removing the said organic compounds and for sintering the said powder;

characterized in that the composition of the said mineral binder and the baking conditions are tailored so that, after the baking, the said mineral binder is in the recrystallized state.

By virtue of the recrystallized state of the mineral binder of the electrodes, the diffusion of metal, especially of silver, during subsequent heat treatments, especially during the baking of the dielectric layer at a temperature above that of the deposited electrodes, is avoided, or at least considerably reduced, even if this temperature is above 500° C.

Preferably, the substrate is based on a soda-lime glass; in this case, the temperature at which the deposited electrodes are baked preferably does not exceed 470° C. so as to avoid any deformation of this substrate; as mineral binder allowing such low baking temperatures, it is then preferable to chose a recrystallizable glass comprising at least one oxide chosen from the group comprising lead oxide (PbO), boron oxide (B₂O₃), silicon oxide (SiO₂), bismuth oxide (Bi₂O₃), aluminium oxide (Al₂O₃), zinc oxide (ZnO) and vanadium oxide (V₂O₅).

According to a variant, the process furthermore comprises the following steps:

after the electrodes have been deposited, the deposition of a dielectric layer;

after the deposited electrodes have been baked, the baking of the whole assembly at a temperature above the maximum temperature reached during the baking of the deposited electrodes.

The dielectric layer is deposited either after the deposited electrodes have been baked or before the deposited electrodes have been baked.

In the first case, the steps of the process are carried out in succession as follows: deposition of electrodes, baking of the deposited electrodes, deposition of a dielectric layer, baking of the whole assembly.

In the second case, the steps of the process are carried out in succession as follows: deposition of electrodes, deposition of a dielectric layer, “baking of electrodes” and then “baking of the whole assembly”; in this case, between the two bakings is generally a heat treatment comprising a first temperature hold, suitable for sintering the powder of the electrode paste and for crystallizing the mineral binder without softening the dielectric layer, and then a second hold at a higher temperature suitable for densifying the dielectric layer.

In general, the temperature reached during the baking of the whole assembly or the temperature of the second hold exceeds 500° C.

Preferably, the electrode paste contains from 3 to 25%, typically 10%, mineral binder. Preferably, the mineral binder is a recrystallizable glass; in order to favour recrystallization, especially at a temperature of less than or equal to 470° C, this glass preferably comprises at least one component chosen from the group comprising chromium, chromium oxide, zirconium, zirconium oxide, titanium and titanium oxide; to be sufficiently effective in terms of crystallization, the weight content of this component in the glass is preferably at least 1%. Preferably, the metal powder of the electrode paste is of a metal chosen from the group comprising silver, copper, aluminium and alloys thereof; this powder preferably has a mean diameter of between 0.4 and 4 μm, preferably between 0.4 and 1 μm. Moreover, this paste contains organic compounds of known type, such as solvent-type materials, photosensitive or non-photosensitive resins, additives.

Further characteristics and advantages of the present invention will appear on reading the description given below, this description being given with reference to the drawings appended hereto in which:

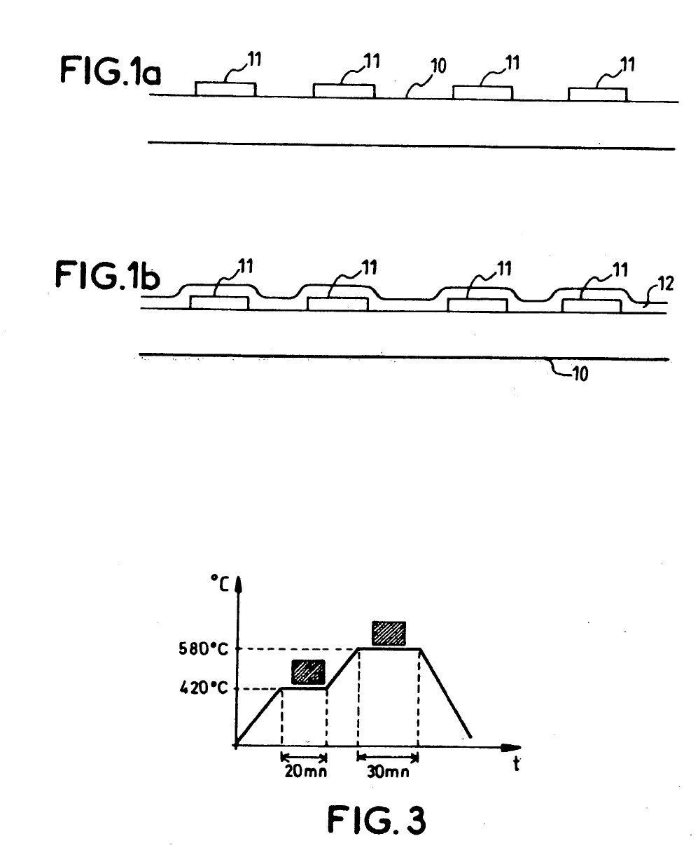

FIGS. 1a and 1b illustrate a first process for producing electrodes on a glass substrate according to the invention;

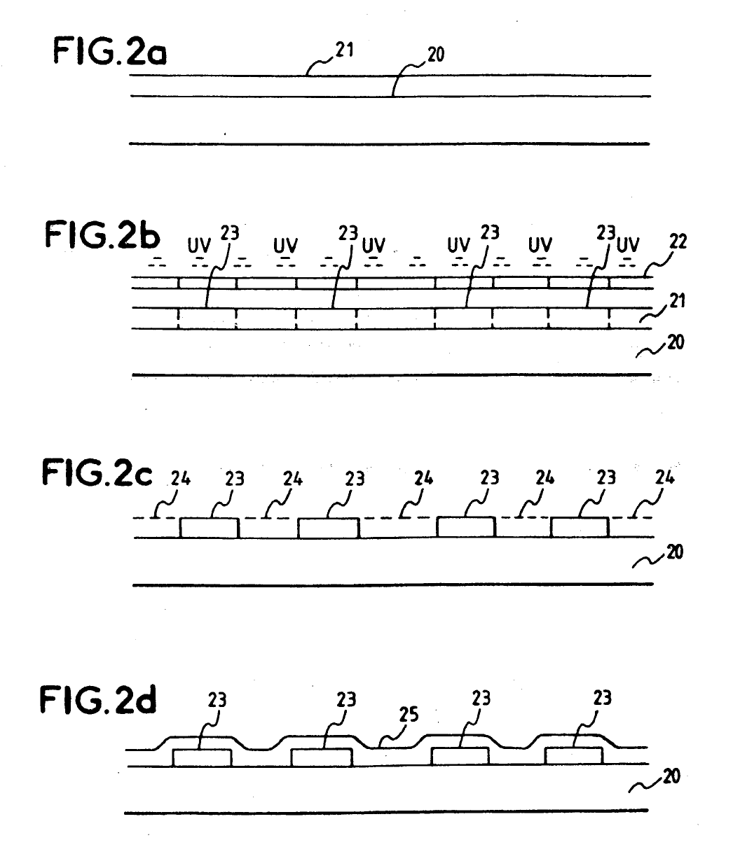

FIGS. 2a to 2d illustrate a second process for producing electrodes on a glass substrate according to the invention; and

FIG. 3 shows a curve giving an example of a baking cycle used in the example with the process of FIGS. 2a to 2d, but it can also be used with the process illustrated in FIGS. 1a and 1b.

The process begins with a conventional soda-lime glass substrate; it is known that the geometry of this type of substrate is inevitably modified if it has to undergo treatments at temperatures greater than or equal to 580° C.; other substrates may also be envisaged.

To produce metal electrodes on this transparent glass substrate, a composition of a paste containing a powder of a metal or a conducting alloy, a mineral binder consisting, according to the invention, of a recrystallizable glass and organic compounds, such as those normally used in pastes of this type, is used.

Preferably, the metal powder or powder of conducting material is a silver or copper powder, or a powder containing at least 70% silver or copper. However, other types of metal powder could be used depending on their ability to conduct the electric current and on their cost, especially powders based on aluminium or an aluminium alloy.

Preferably, the recrystallizable glass comprises at least one oxide chosen from the group comprising lead oxide (PbO), boron oxide (B₂O₃), silicon oxide (SiO₂), bismuth oxide (Bi₂O₃), aluminium oxide (Al₂O₃), zinc oxide (ZnO) and vanadium oxide (V₂O₅).

Preferably, the composition of this glass is chosen so as to be able to carry out the baking, especially so as to sinter the conducting powder and then crystallize the mineral binder, at a baking temperature of less than or equal to 470° C.; thus, a mineral binder is preferably chosen whose softening point is less than 450° C.; since it is generally necessary to heat to 350° C. to completely remove the organic compounds from the electrode paste, a mineral binder is preferably chosen whose softening temperature exceeds 350° C.

So that this glass can easily recrystallize under the baking conditions, that is to say so that extensive crystallization can develop during the baking, the mineral binder of the paste preferably contains at least one element chosen from the group comprising chromium, zirconium and titanium in metal or oxide form. With such a composition, it is thus particularly easy to determine baking conditions which allow this binder both to soften sufficiently and to recrystallize; the softening is conventionally intended to facilitate the sintering of the silver particles and to ensure bonding and adhesion to the substrate; the recrystallization makes it possible, according to the invention, to obtain a binder in which the metal of the powder, especially silver, will diffuse much less easily than in the prior art, so as to limit, if not eliminate, the yellowing problems in a very inexpensive manner.

The presence of the abovementioned components favours the crystallization which starts as soon as the glass is heated to its softening point. For example, if a glass is used which has a softening temperature of 380° C., such as a lead silicate containing 15% silica (SiO₂) by weight, and 5% chromium is added to it, then rapid crystallization occurs around 450° C. Consequently, simply heating at 450° C. for 15 minutes is sufficient to transform a significant part of the glassy phase into a crystalline phase and the material then becomes almost inert with respect to temperature. Thus, during a second baking at a higher temperature, especially that for the dielectric layer, and even in the presence of a molten glass, such as a lead borosilicate used especially for the dielectric layers, no yellowing occurs, the pattern of the electrodes containing the crystallized glass is stable and the deposited electrodes continue to adhere to the substrate.

Thus, using a glass having a low softening temperature, such as that described above, the electrode array may be baked at low temperature while still allowing this glass to recrystallize; the possibility of baking at low temperature advantageously eliminates any risk of the soda-lime glass substrate deforming since the baking is carried out at a temperature of less than or equal to 470° C. Furthermore, a significant economic saving is made since baking at 450° C. has a lower energy cost than baking at 580-590° C. In addition, the furnace needed for the baking operation may be of average temperature uniformity, namely ±5° C. or even ±10° C.; it is therefore much less expensive.

As mentioned above, the composition of the metallic ink or paste used for producing the electrodes of a plasma panel contains conventional organic compounds, especially resins, solvents or additives. These organic compounds will differ depending on whether a photosensitive or photoimageable paste or ink or a paste or ink used with conventional screen-printing technologies is involved.

Thus, for photoimageable inks, a photosensitive resin is used which may be of the positive or negative type. In this case, the sensitizing compound may, for example, be potassium, sodium or ammonium dichromate or a diazo compound or any other component making the resin used sensitive to light (visible or UV). The sensitizing compound is mixed with the resin, which may be of the polyvinyl type, in proportions ranging from 0.1 to 1%. Additives which fix the rheology or improve the quality of the paste may be added to this photosensitive resin. These additives may be of the plasticizer, thixotropic-agent, adhesion-promoter or surfactant type. In this case, they modify the resin solution. If the additives of the dispersing type, they are used to stabilize the suspension of mineral powders. Thus, a photosensitive paste or ink contains a photosensitive resin such as that mentioned above, additives such as those mentioned above, a filler made of a metallic material or a material containing more than 70% of a metallic material, preferably silver or copper, consisting of a powder whose mean diameter lies between 0.4 and 4 μm, preferably between 0.4 and 1 μm, and a mineral binder which provides the adhesion to the substrate and the sintering of the metal particles and is composed of a recrystallizable mineral glass, as mentioned above, which preferably does not induce spontaneous polymerization of the resin. The example is based on a polyvinyl resin; however, the invention is applicable to the various commercial compositions based on different resin systems.

As in the case of inks or pastes used in conventional screen printing, that is to say those which are not photosensitive, the paste therefore includes one or more organic resins to which, for example, one or more organic solvents and one or more organic binders are added. The heavy and not very volatile solvents normally used are chosen from terpineol, butyl carbitol and dodecanol. The actual resin, consisting for example of ethylcelluloses or methyl methacrylates, is dissolved in these solvents. In a known manner, additives are added, on the one hand, to modify the resin solution, these additives then being of the plasticizer, thixotropic-agent, adhesion-promoter or surfactant type, and, on the other hand, to stabilize the suspension of mineral powders. In this case, the additives are dispersants. The paste also contains a mineral part consisting of a metallic filler, such as silver, copper or aluminium, or a material rich in silver, copper or aluminium or an aluminium-based alloy (for example Al—Cu) in the form of a powder whose mean diameter lies between 0.4 and 4 μm, preferably between 0.4 and 1 μm, and of a mineral binder, such as a recrystallizable glass as described above, the role of which is to ensure adhesion to the substrate and sintering of the metal particles.

A first embodiment of an electrode array on a tile made of glass, especially a glass of the soda-lime type, for producing a matrix PP, will now be described with reference to FIGS. 1a and 1b.

According to the present invention, a tile 10 of bare glass, in general a glass of the soda-lime type, is used. A paste is prepared which contains:

100 g of a resin obtained by dissolving 5 g of ethylcellulose in 95 g of terpineol;

150 g of a silver powder having a mean diameter of 0.8 μm;

20 g of a recrystallizable mineral glass obtained by adding 5% of titanium to a zinc bismuth silicate;

0.5 g of a surfactant, like the one sold under the brand name “OROTAN” 850 E by Brenntag Spécialités.

This paste is deposited in a known manner by screen printing through a mask formed on a “325 mesh” screen and representing the pattern of the array to be produced, typically the array of electrodes 11 having a width of 150 μm and a thickness of 4 μm. Next, these are dried at 120° C. for 10 minutes and then baked at 460° C. for 20 minutes, so as to obtain the said electrodes 11 with a mineral binder in the recrystallized state.

Next, as shown in FIG. 1b, a dielectric layer, such as a layer of lead borosilicate glass, is deposited. This layer 12 is deposited by screen printing, then dried at 120° C. and baked at 580° C. for 30 minutes. The process for producing a rear tile of a matrix plasma panel may be concluded by depositing barriers and phosphors in a conventional manner.

Despite these high treatment temperatures, yellowing of the dielectric layer is no longer observed, this layer remaining highly transparent owing to the recrystallized state of the mineral binder of the electrode array into which the silver diffuses much less easily than in the prior art.

A process for producing a tile of a plasma panel using a photosensitive paste will now be described with reference to FIGS. 2a to 2d. In this case, a tile 20 of glass, such as a soda-lime glass, is used, onto which is spread, by screen printing, over the entire surface of the tile, a paste or ink 21. This photosensitive paste contains:

100 g of a photosensitive resin consisting, for example, of 10 g of 14/135 grade polyvinyl alcohol dissolved in 100 g of water;

2 g of sodium dichromate used as resin photosensitizer;

100 g of a silver powder of 0.8 μm mean particle diameter;

15 g of a recrystallizable mineral glass that does not react with the photosensitive resin, consisting, for example, of vanadium oxide and silver oxide (softening temperature: 340° C.) to which 5% of zinc oxide has been added;

1 g of a surfactant such as that sold under the brand name “OROTAN” 850 E by Brenntag Spécialités.

As shown in FIG. 2a, this paste is deposited by screen printing through a mask formed on a “325 mesh” screen so as to form a layer 21 covering the entire surface of the tile 20. This layer 21 is dried at 80° C. for 5 minutes.

As shown in FIG. 2b, the layer 21 is exposed to UV radiation through a mask 22. If the resin is a negative photoresist, the pattern to be transferred is that of the open areas on the mask. In the embodiment shown, the electrodes 23 have a width of 70 μm and a thickness of 4 μm. The exposed layer is developed in water so as to remove the parts 24. Then, by drying, the final pattern 23 is revealed.

As shown in FIG. 2d, a paste containing a glass frit, such as lead borosilicate, is then conventionally deposited by screen printing, this paste producing the dielectric layer 25.

Finally, the whole assembly consisting of the array of electrodes 23 and the dielectric layer 25 is then baked in one and the same thermal cycle, as shown in FIG. 3. The thermal cycle comprises a first step consisting of a 10° C./minute heating ramp up to a first temperature of 420° C. followed by a temperature hold of 20 minutes in the method of implementation shown. This first temperature may be between 380° C. and 470° C., depending on the properties of the recrystallizable glass used. This first step of the thermal cycle is designed to achieve, apart from the sintering, the recrystallization of the mineral binder of the electrode array.

This first step is followed by a second step comprising a heating ramp up to a temperature of 580° C. followed by a hold at 580° C. for 30 minutes in the method of implementation shown. The second temperature is between 530° C. and 600° C., depending on the properties of the dielectric layer used.

Despite these high treatment temperatures, there is no longer any yellowing of the dielectric layer, which remains highly transparent owing to the recrystallized state of the mineral binder of the electrode array into which silver diffuses much less easily than in the prior art.

This method of implementation may be used for manufacturing the rear tile of a matrix PP. It can also be used for producing the sustain electrodes of the front tile of a coplanar PP. In this case, transparent address electrodes made of ITO (indium tin oxide) or of tin oxide may be produced beforehand on the tile.

According to another method of implementation, the paste or ink used for producing the electrodes of a plasma panel was obtained in the following manner:

Preparation of a resin solution: solution R1.

| | | | |
|---|---|---|---|
| Solvent | Terpineol | 73.5 | g |
| Resin | N7-grade ethylcellulose | 7.0 | g |
| Plasticizer | SANTICIZER S 160 | 6.5 | g |
| Dispersant | Lecithin | 4.0 | g |

Addition of an additive to R1 so as to obtain a thixotropic binder: solution B1.

| | | | |
|---|---|---|---|
| Resin solution | R1 | 91.0 | g |
| Thixotropic agent | THIXATROL | 9.0 | g |

Preparation of the silver ink by mixing the following components:

| | | | |
|---|---|---|---|
| Binder solution | B1 | 20.0 | g |
| Silver powder | Ag DC100 | 72.0 | g |
| Recrystallizable mineral glass | | 8.0 | g |

(18.5% SiO₂, 4.5% B₂O₃, 72% PbO, 5%
Cr₂O₃)

It is obvious to those skilled in the art that the examples given above may be different, especially as regards the composition of the recrystallizable glass, the resins, the solvents, etc., without departing the scope of the claims.

1. Process for manufacturing a plasma panel tile, comprising the following steps:
deposition of electrodes on a substrate, in a defined pattern, using a paste comprising a metal powder, a mineral binder and organic compounds;
baking of the said deposited electrodes under conditions suitable for removing the said organic compounds and for sintering the said powder; characterized in that the composition of the said mineral binder and the baking conditions are tailored so that, after the baking, the said mineral binder is in the recrystallized state.

2. Process according to claim 1, characterized in that the said substrate is based on a soda-lime glass.

3. Process according to claim 2, characterized in that the temperature at which the deposited electrodes are baked does not exceed 470° C.

4. Process according to any one of the preceding claims, characterized in that it furthermore comprises the following steps:
after the electrodes have been deposited, the deposition of a dielectric layer;
after the deposited electrodes have been baked, the baking of the whole assembly at a temperature above the maximum temperature reached during the baking of the deposited electrodes.

5. Process according to claim 4, characterized in that the maximum temperature reached during the said baking of the whole assembly is greater than 500° C.

6. Process according to either of claims 4 and 5, characterized in that the dielectric layer is deposited after the deposited electrodes have been baked.

7. Process according to either of claims 4 and 5, characterized in that the dielectric layer is deposited before the deposited electrodes have been baked.

8. Process according to any one of the preceding claims, characterized in that the mineral binder consists of a recrystallizable glass.

9. Process according to claim 8, characterized in that the said glass comprises at least one recrystallizing component chosen from the group comprising chromium, chromium oxide, zirconium, zirconium oxide, titanium and titanium oxide.

10. Process according to claim 9, characterized in that the weight content of this recrystallizing component in the said glass is greater than 1%.

11. Process according to any one of the preceding claims, characterized in that the metal powder is of a metal chosen from the group comprising silver, copper, aluminium and alloys thereof.
